(19) United States
(12) Patent Application Publication
(10) Pub. No.: US 2004/0030645 A1
(43) Pub. Date: Feb. 12, 2004

(54) Method and system for performing a transaction utilising a thin payment network (mvent)

(76) Inventor: Stephen Monaghan, Singapore (SG)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/297,654

(22) PCT Filed: Apr. 12, 2002
(86) PCT No.: PCT/SG02/00059

(51) Int. Cl. G06F 17/60

(52) U.S. Cl. 705/40; 705/39

(57) ABSTRACT

A method for performing a transaction to enable a consumer to purchase a good or service from a merchant, the method including the steps of the consumer providing identification to the merchant, the merchant forwarding purchase details to a processing means verifying the consumer details and forwarding the purchase details to a first financial institution, the consumer having an account with the first financial institution, the first financial institution verifies the consumer details and forwards a message to the consumer requesting authentication of the transaction, the consumer replies to the first financial institution authenticating the transaction, the first financial institution forwards a message to the processing means authorising the transaction and arranges transfer of funds to a second financial institution, the merchant having an account with the second financial institution and the processing means advising the merchant that the transaction is authorised, as shown in FIG. 2.

### FIELD OF THE INVENTION

The present invention relates generally to the field of electronic commerce, and more particularly to a method and system for performing a transaction utilising a thin payment network.

### BACKGROUND OF THE INVENTION

FIG. 1 represents the existing credit card model for payment generation at a merchant level. Fundamentally, the manner in which the credit card model works is that there are several key parties in a transaction in addition to the merchant 2 and the consumer 1. One of those key parties is an acquiring financial institution 3, which actually furnishes the point-of-sale (POS) or “swipe-card” machines to the merchant 2. Another of those key parties is an issuing financial Institution 6, which brands the card. For example, for a consumer who carries a particular bank's credit card, the particular bank is the issuing financial institution.

From a process flow standpoint, in the existing credit card model, when a consumer 1 enters into a merchant transaction, the consumer 1 produces his or her credit card. The credit card is swiped in the POS machine, and a message, including all the transaction information and the consumer's details around the card and process, is then transferred to the acquiring financial institution 3, which furnished the POS machines to the merchant 2. From there, for “on-us” transactions, which means the issuing financial institution 6 and the acquiring financial institution 3 are the same, the transaction information goes directly back to the merchant 2 with a confirmation.

In the existing credit card model process, where the issuing financial institution 6 and the acquiring financial institution 3 are different, the process is that the merchant 2 transfers the information to the acquiring financial institution 3, which then routes the information through to a particular credit card association 4. The credit card association 4 then routes the information to the issuing financial institution 6. At that point, the credit lines of the consumer 1 are checked for funds availability, and the funds within that facility are earmarked. Assuming that there is an available balance, an authorisation is then routed back through the card association 4 out to the acquiring financial institution 3 and out to the merchant 2. The consumer 1 can then take the goods and leave. The existing credit card model utilises authorisation rather than authentication, which is the first and major process. When a transaction is authorised, all that is being said is that the credit card account with a particular card number and expiry date has funds or credit available to it. Authorisation simply confirms that a particular account has funds, but it does not authenticate the individual attempting to use the credit card account in a transaction. Thus when the holder of the card that was used in the transaction receives his or her credit card statement at the end of the month, the cardholder may dispute the transaction, and if successful, leave the merchant exposed to a liability, or if unsuccessful, leave the consumer exposed to liability.

It is noted that in the existing credit card model, that no reference is made to the consumer's financial institution 5. Rather, consideration is given only to the credit card account and not to funds which may or may not be available in the consumer's account.

In addition, the existing credit card model provides a very inefficient financial supply chain. It potentially has two intermediating parties that may not be necessary in a transaction but with whom the consumer's confidential information is being shared and who are adding costs to the transaction. For example, if the issuing financial institution is different from the acquiring financial institution, the card association and the acquiring financial institution are additional parties sitting in the middle of the transaction.

### OBJECT OF THE INVENTION

It is therefore an object of the present invention to provide a more efficient system for performing a transaction which reduces the necessity for confidential information to be forward to intermediates in the payment process flow.

### SUMMARY OF THE INVENTION

With the above object in mind the present invention provides in one aspect a method for performing a transaction to enable a consumer to purchase a good or service from a merchant, the method including the steps of:

the consumer providing identification to the merchant;

the merchant forwarding purchase details to a processing means, the purchase details including purchase value and consumer details indicated by the identification;

the processing means verifying the consumer details and forwarding the purchase details to a first financial institution, the consumer having an account with the first financial institution;

the first financial institution verifies the consumer details and forwards a message to the consumer requesting authentication of the transaction;

the consumer replies to the first financial institution authenticating the transaction;

the first financial institution forwards a message to the processing means authorising the transaction and arranges transfer of funds to a second financial institution, the merchant having an account with the second financial institution; and

the processing means advising the merchant that the transaction is authorised.

In a further aspect the present invention provides in one aspect a system to facilitate the purchase of goods and/or services from a merchant by a consumer, including:

a first financial institution holding an account of the consumer;

a second financial institution holding an account of the merchant; and

a processing means;

wherein the merchant obtains identification from the consumer and forwards purchase details to the processing means, the processing means verifies consumer details and forwards purchase details to the first financial institution, the first financial institution seeks authentication of the transaction from the consumer and upon receiving authentication forwards authorisation to the processing means and initiates payment to the second financial institution, and the processing means forwards approval to the merchant.

In yet a further aspect the present invention provides in one aspect a system to facilitate the purchase of goods and/or services from a merchant by a consumer, wherein the system provides the consumer with a unique identification, and wherein the system receives consumer identification and purchase value from the merchant, the system verifies the consumer identification includes the unique identification and forwards the consumer identification and the purchase value to a first financial institution nominated by the consumer and awaits authorisation, the system receives the authorisation from the first financial institution and forwards the authorisation to the merchant

It is a feature and advantage of the present invention to provide a method and system for performing a transaction utilising a thin payment network with non-invasive back-end infrastructure that reduces costs and complexity in consumer-to-business and peer-to-peer payment processes.

It is a further feature and advantage of the present invention to provide a method and system for performing transaction utilising a thin payment network that disintermediates consumer payments to merchants and realigns financial institutions with consumers.

It is another feature and advantage of the present invention to provide a method and system for performing a transaction utilising a thin payment network with a thin infrastructure that does not intermediate the financial institution relationship with payers and payees.

To achieve the stated and other features, advantages and objects, an embodiment of the present invention provides a method and system for performing a transaction utilising a thin payment network, an important feature of which is initiation of authorisation by a consumer rather than by the bank. In the system of the present invention, when the consumer goes to a merchant and purchases goods, the merchant invoices the consumer for the goods. The information is encrypted from the merchant's side and is essentially the equivalent of an invoice rather than a request for any earmarking of funds for payment. The invoice is encrypted, and the only information that is transferred to the merchant is an identity.

That information is routed through the system of the present invention into the consumer's financial institution where it is presented as an invoice. From that point, the invoice is presented back to the consumer. Thus, the consumer, through logging in to his or her usual bank account can then initiate the transaction through the consumer's bank, which means the bank has authenticated the particular consumer. When the consumer initiates the transaction, the bank tells the consumer if he or she has sufficient funds available, and if so, authorises the transaction back to the merchant via the system. Thus, the transaction is not simply authorised, but it is actually authenticated. At the same time, the same invoice information is passed to the merchant bank account. Thus, using existing infrastructure between financial institutions for the transfer of money, when the financial institutions settle the money, a self-reconciling system is created.

Additional objects, advantages and novel features of the invention will be set forth in part in the description which follows, and in part will become more apparent to those skilled in the art upon examination of the following, or may be learned from practice of the invention.

### BRIEF DESCRIPTION OF THE DRAWINGS

FIG. 1 illustrates an example of typical credit card process steps in a credit card association model;

FIG. 2 illustrates an example of the process steps in the thin neutral network for an embodiment of the present invention;

FIG. 3 illustrates a payment model application for an embodiment of the present invention;

FIGS. 4 to 10 show the process flow of one embodiment of the present invention.

FIGS. 11 to 15 show a process flow of an alternative embodiment of the present invention.

FIGS. 16 to 20 show a process flow of an alternative embodiment of the present invention.

FIGS. 21 to 23 show a sample process flow of a settlement and reconciliation process.

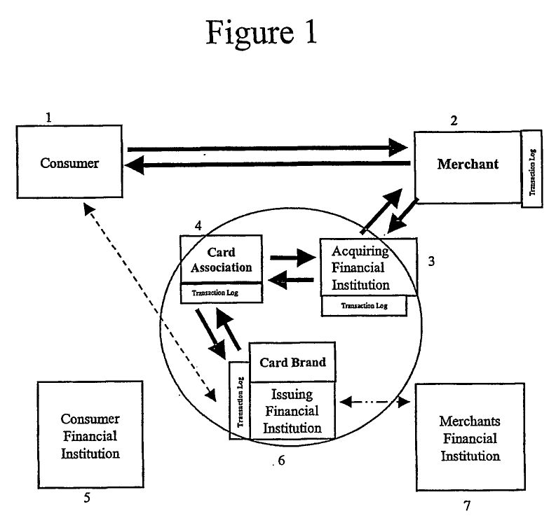

### DESCRIPTION OF PREFERRED EMBODIMENT

Referring now in detail to an embodiment of the present invention, an example of which is illustrated in the accompanying figures, a key aspect of the system for an embodiment of the present invention is that it moves completely away from the existing model, which passes confidential information that can be used to execute a transaction. For example, in the existing model, knowledge of the consumer's credit card number and expiry date, which is encapsulated in the existing process flow, is sufficient for anyone to actually initiate a transaction on the consumer's credit card. However, an important feature of the system for an embodiment of the present invention moves away from the existing process to a process in which the authorisation is initiated by the consumer rather than by the bank. While terms such as “consumer” and “customer” are used herein, it is to be noted that such use is not intended as a limitation, and an embodiment of the present invention includes transactions involving, for example, commercial or corporate purchases as well.

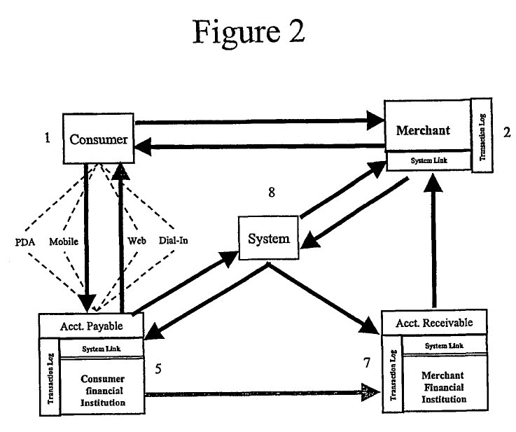

Referring, for example to FIG. 2 showing one embodiment of the present invention, when a consumer 1 goes to a merchant 2 and purchases goods, the merchant 2 invoices the consumer 1 for the goods. The information is encrypted from the merchant's side and is essentially the equivalent of an invoice rather than a request for any earmarking of funds for payment. The invoice is encrypted, and the only information that is transferred to the merchant 2 is an identity. The identity can include, for example, an email address, mobile phone number or alphanumeric code or any other sort of identification set by the consumer 1 that the consumer 1 registered as a unique identity within the system of the present invention or a randomly generated number or alphanumeric given to said consumer by consumer's financial institution.

That information is routed through the system 8 of the present invention into the consumer's financial institution 5, where it is presented as an invoice. From that point, the invoice is presented back to the consumer 1. Thus the consumer 1, through logging in to his or her usual bank account using the same security process that is placed around any transaction initiation, can then initiate the transaction through the consumer's bank 5, which means the bank has authenticated the particular consumer 1, such security process includes any security process that the consumer's bank 5 may provide or in time may evolve, such as provision of mart cards or the like.

When the consumer 1 initiates the transaction, the bank 5 tells the consumer 1 if he or she has sufficient funds available, and if so, authorises the transaction back to the merchant 2 via the system 8 for an embodiment of the present invention. Thus, the transaction is not simply authorised, but it is actually authenticated. At the same time, as one aspect of the process of the preferred embodiment of the present invention, that same invoice information can be passed to the merchant bank 7 account. Thus, using existing infrastructure between financial institutions for the transfer of money, when the financial institutions settle the money, a self-reconciling system is created.

In the system for an embodiment of the present invention, when the invoice is presented, it is presented in two places. It is presented to the consumer 1 for initiation and for authentication and authorisation. It is also presented to the merchant 2 as an accounts receivable. Therefore, there is an accounts payable and an accounts receivable. When the payment is actually initiated and settlement occurs through normal banking processes using existing infrastructure, a reference number for the invoice is taken from the invoice and passed as a reference field within the settlement instruction. When the settlement instruction goes to the merchant's financial institution 7, the invoice number is then knocked off so the accounts receivable is then turned into a paid history. Thus, the system 8 of the present invention is a full settlement system versus simply an authorisation system.

In terms of the process steps for the preferred embodiment of the present systems, a consumer 1 selects a product or service to be purchased from a merchant 2. To purchase the product the consumer 1 scans a barcode, enters information on a web interface, or in some other manner provides identification to the merchant 2 so as to enable the consumer to be identified by the system 8. Upon receipt of this identification the merchant 2 effectively generates an invoice for the product or the service and forwards this invoice to the system 8. The system 8 then routes copies of the invoice to the consumer's financial institution 5 and also to the merchant's financial institution 7. Contact is then made between the consumer 1 and the consumer's financial institution 5 by any bank interface channel so as to seek approval and authentication from the consumer 1 for the purchase of the goods or service. Assuming that the purchase is legitimate, and that sufficient funds are in the consumers account, the consumer authorises and authenticates the transaction by entering a password or some other means established to indicate that the consumer 1 approves of the transaction. On receipt of the consumers approval, the consumer's financial institution 5 sends a message to system 8 indicating approval. The system 8 then acknowledges this approval to the merchant 2 who then releases the goods or service to the consumer 1. The consumers financial institution 5 can also send the approval to the merchants financial institution 7 and through existing bank payment processing infrastructure payment can be made from the consumers financial institution 5 to the merchant financial institution 7.

In this way unlike the existing credit card model the consumer's financial institution 5 is a part of the payment process. Further, the consumers information is only shared by three parties who are all involved in the process.

An important advantage of the system for an embodiment of the present invention is that it significantly lowers the risk of fraud. From the merchant's standpoint, merchants are currently subject to liability for that fraud. In the system of the present invention, that liability moves to the consumer, and the consumer can better control his or her own security. Thus, if the consumer discloses his or her personal identification number (PIN) or other secret information to a third parry, it is at the consumer's own risk. From an economic standpoint, it means that the risk is moved from the merchant to the consumer, and the cost structure is moved from the merchant, which potentially leads to lower pricing. Further, from a process flow standpoint, the merchant is now guaranteed its funds.

From the merchant's standpoint, a significant cost is associated with the reconciliation of all transactions. The system for an embodiment of the present invention provides a mechanism by which that reconciliation is fully carried out for the merchant in a very automated way. Further, from the consumer's standpoint, the consumer's confidential information is no longer held in an unsecured third party. The system for of the present invention does not retain any information but is purely a transaction and routing system. In a sense, the system of the present invention provides a type of “yellow pages” for the direction of the invoices.

In the process for an embodiment of the present invention, a transaction is no longer purely a credit or debit type transaction, but the system of the present invention gives access for the consumer to pay by any method that is available to the consumer within the consumer's bank account. Thus, it is a homogenous process, regardless of the method of payment, which may extend itself not only to credit or debit, but may move into reward programs and other methods of payments, so they are all provided by the financial institution.

Another advantage of the system for an embodiment of the present invention is that it provides the consumer much greater control over the payments out of the consumer's account. What that means for the consumer is that, as he or she spends on the use of the payment methodology of the present invention, the consumer has a full history of every penny that leaves his or her wallet. Another key aspect is that the system of the present invention is a “just in time” payment system. In other words, because the money is held within the consumer's bank account and not, for example, in a cash situation with the consumer withdrawing cash from the account, the consumer continues to earn interest right up until the point of payment.

The system for an embodiment of the present invention provides a homogenous process, whether the consumer uses, for example, the web or a personal digital assistant (PDA) or a mobile phone. For example, a consumer with his or her mobile phone walks into a merchant's store and at some point, the merchant indicates that it is time to pay for the transaction. The consumer brings up a bar code and swipes the bar code through a scanner, which is simply a way of transferring the consumer's identity to the merchant system. The consumer could just as easily give his or her email address, mobile phone number or alphanumeric code or any other sort of identification. It is not necessary for the consumer to even have a device, so the consumer can walk into a store and execute the transaction without cash or a mobile phone or anything else.

When the consumer walks into a store, the consumer passes his or her identity at the end of the transaction when the merchant rings up the total. An encrypted invoice for the transaction is than routed through the system for an embodiment of the present invention. The contents of the invoice are never decrypted by the system of the present invention, so the system has no visibility of what lies beneath. All that the system of the present invention does is route the transaction, so the system decrypts only the routing information. The encrypted invoice is then routed to both the accounts payable, which is the consumer's financial institution, and the accounts receivable, which is the merchant's financial institution.

In the case of the consumer with a mobile phone, a message is then routed, for example, to pop up on the consumer's mobile phone notifying the consumer that he or she has an invoice waiting from the particular merchant, with the amount, and prompting the consumer to choose any of the payment facilities that he or she has available within the consumer's bank, such as debit/credit or rewards points. If the consumer chooses, for example, debit, the consumer enters his or her PIN and authorises the transaction. The consumer's financial institution confirms that the funds available are correct and that the transaction can be executed. An authorisation number is then sent back to the merchant by the system for an embodiment of the present invention, and the consumer can walk away with the goods.

In the system for an embodiment of the present invention, the monetary settlement is subject to the local infrastructure that is available for clearing for the financial institution. For example, in Singapore the settlement may occur the following day. When the settlement instruction is passed from the consumer's financial institution to the merchant's financial institution, that information is taken, and the invoice numbers are reconciled at the merchant's financial institution. Thus, the physical flow of money occurs as per the standard settlement process times within each country.

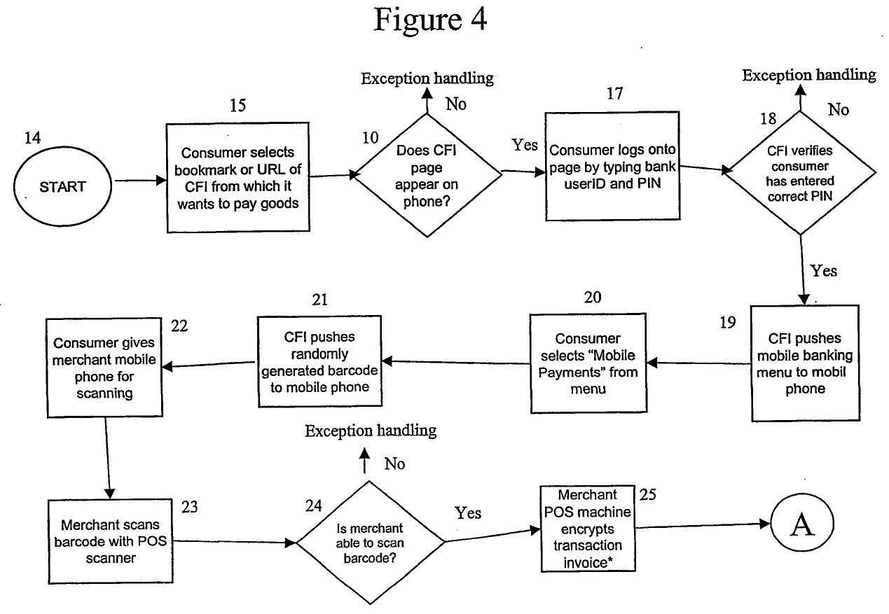

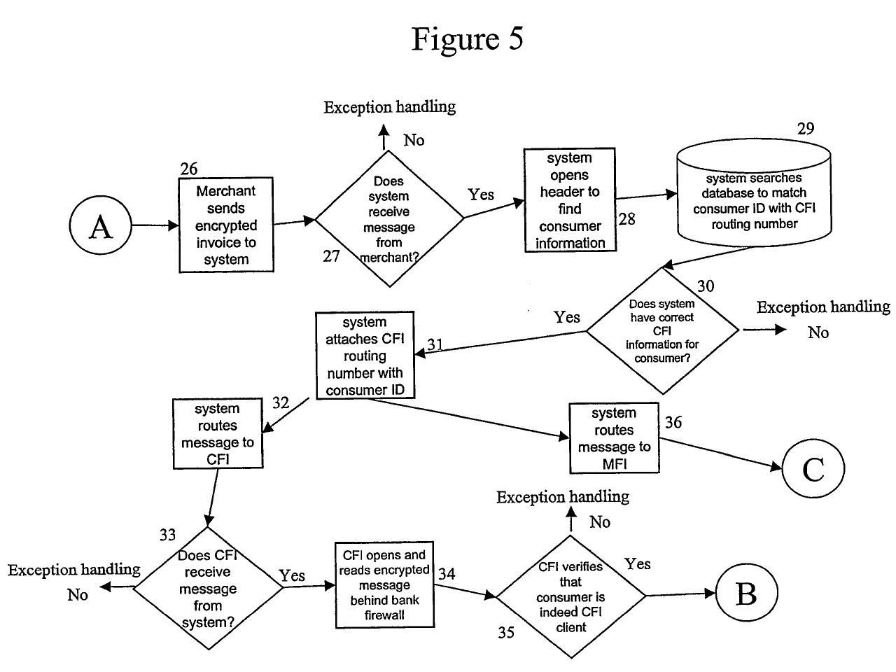

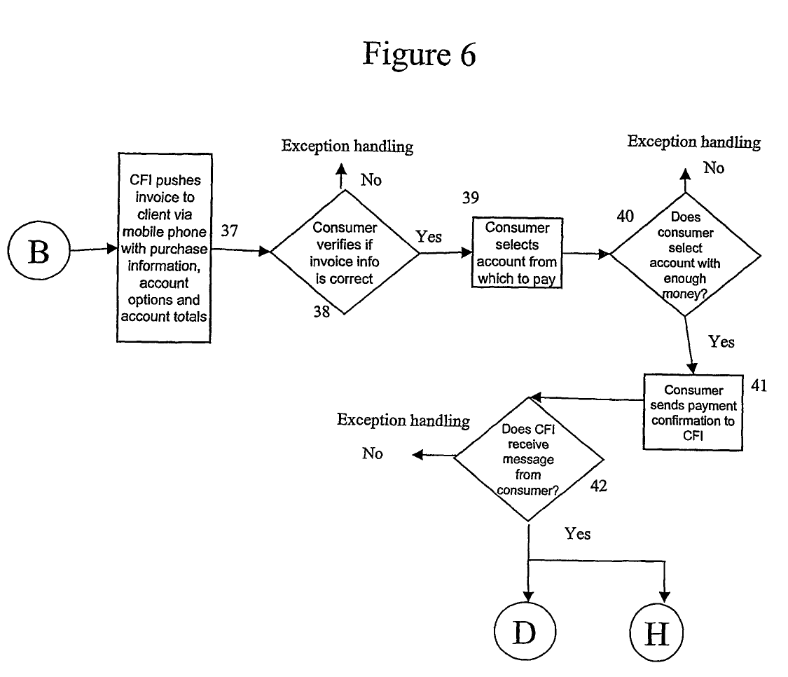

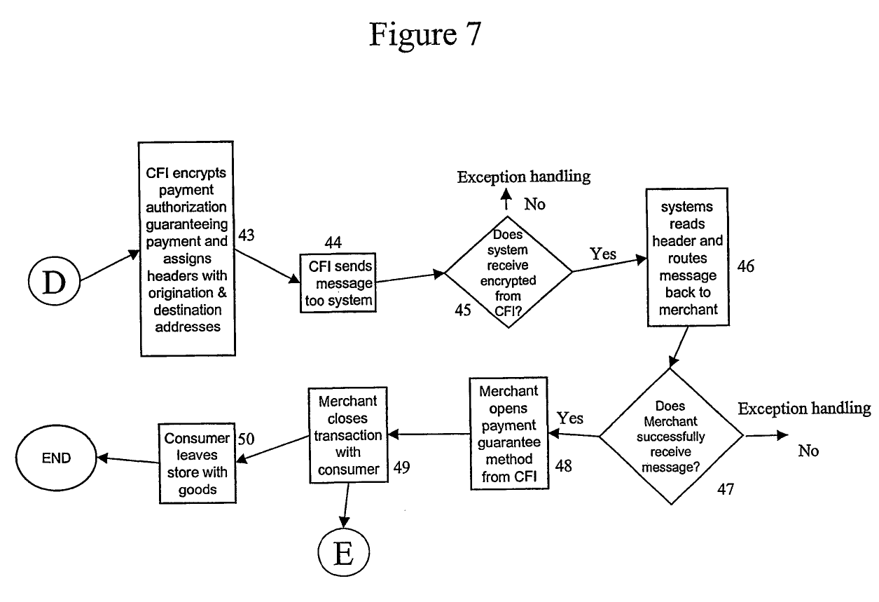

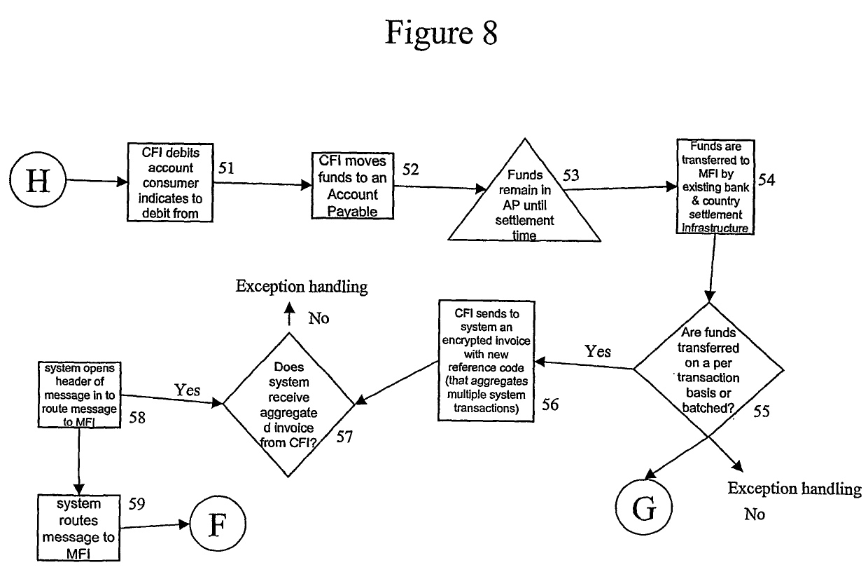

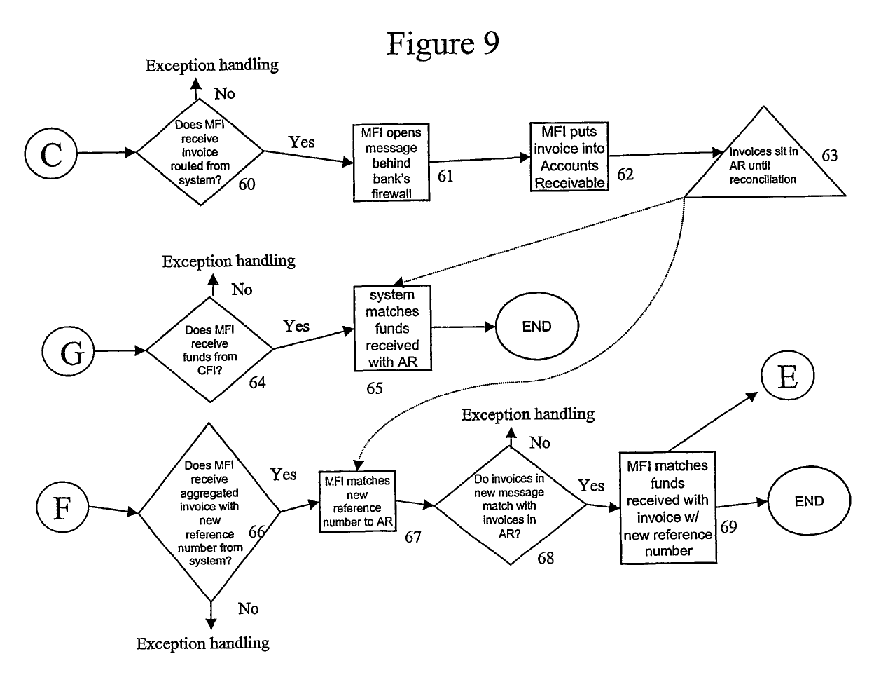

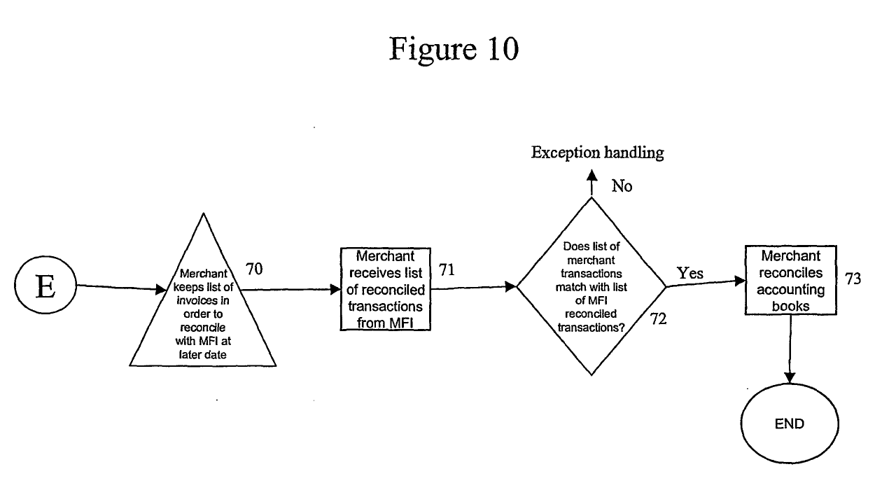

Considering now an example embodiment of the present invention reference is made to FIGS. 4 to 10 which show a consumer to business process flow using a mobile phone as the contact between the consumer and the consumers financial institution. In order for the consumer to obtain suitable identification to provide to a merchant it is necessary for the consumer to “initialise” the system. This may be commenced by the consumer selecting the URL 15 of the consumer's financial institution. Assuming that the consumers financial institution is able to be shown on a phone 16 then the consumer logs 17 onto the page by entering a suitable user ID and pin number. The financial institution will then verify 18 that the information entered by the consumer is valid and correct. Assuming that the consumer is authenticated by the financial institution then the financial institution pushes a mobile banking menu to the consumer's mobile phone 19. The consumer is then required to select “mobile payments” from the menu 20, upon which the consumer's financial institution randomly generates a barcode 21 to the mobile phone. In some applications a menu may not be provided to the consumer, and the financial institution may simply forward a barcode to the consumer. The system may also be set up such that a random barcode is generated each time a consumer wishes to make a purchase or alternatively a unique barcode may be assigned by the financial institution to each particular consumer. That is the identification process can be fixed in that for example, one barcode is assigned and kept by a user for all purchases. Alternatively, the preferred system will be random or dynamic in that for example, a new barcode, or other means of identification, will be generated for each transaction.

Once the consumer has selected a good or service to purchase from a merchant, the consumer can provide the mobile phone 22 to the merchant for scanning. The merchant can then scan 23 the barcode with a point of sale scanner. Alternatively the merchant may read the barcode or some other authorisation number from the phone and enter it into the merchants system. Assuming that the merchant is able to scan the barcode 24 or receive the necessary identification from the consumer then they merchants system encrypts a transaction invoice 25. This invoice will include information such as the identification of the consumer and the cost of the goods or services which the consumer seeks to purchase. Other information may also be included depending on the implementation.

The encrypted invoice is then forwarded to the system 26 by the merchant. Once the system receives the message 27 from the merchant, the header 28 to the message is opened so as to ascertain the consumer information. The system them searches through its database 29 so as to match the consumer ID with the routing number. If the consumer data stored on the system does not match, then an error is generated 30. Alternatively, the system attaches the consumer financial institution routing number with the consumers ID 31 and then forwards the message to the merchant's financial institution 36 and also the consumers financial institution 32. Once the consumers financial institution receives the message 33 from the system, it opens and reads the encrypted message 34. The consumer's financial institution, for example the consumer's bank, then verifies that the consumer is one of their clients 35 and does hold an account with that financial institution. The consumer's financial institution can then check whether the consumer has sufficient funds to effect payment of the invoice. The system could be configured so that if insufficient funds are present, the message will be sent back to the system and thereby to both the merchant and consumer.

Following the authentication that the consumer is a customer of the financial institution the consumers financial institution will push invoice data to the consumer 37. This data may include the purchase information such as the cost of the goods or services to be purchased together with account details and account totals. In this way the consumer will be able to select an account to debit for the transaction. Alternatively, if only a single account is available or the consumer has only set up the system in respect of a single account these details may be forwarded. The consumer will receive this message on their mobile phone, and will then need to verify if the invoicing information is correct 38. Assuming that the invoice information is correct, and choices are available the consumer will then select 39 which account is to be debited for the transaction. At this point the consumers financial institution may verify 40 that sufficient funds are available in the account selected by the consumer to purchase the transaction.

The consumer's financial institution may then seek confirmation 41 from the consumer to proceed with the transaction. Alternatively the system could be implemented such that should the consumer select or verify that the transaction was correct the transaction will automatically proceed without the additional verification step. The consumers financial institution will not proceed further with the transaction until a message is received 42 from the consumer.

Assuming that the consumer does confirm that the transaction is to proceed, the consumer's financial institution will need to debit the consumers account and also provide a guarantee to the merchant. To guarantee payment and therefore enable the consumer to take possession of the goods, the consumer's financial institution will encrypt payment authorisation 43 and send this message 44 to the system. Once the system receives the encrypted message 45 from the consumer's financial institution the system reads the header 46 to the message and thereby routes the message to the correct merchant. Once the merchant receives the encrypted message 47 the merchant then opens the message 48 to ensure that payment will be made. The merchant then closes the transaction with the consumer 49, and the consumer is able to leave 50 with the purchased goods.

Following confirmation from the consumer to proceed the consumer's financial institution 51 debits the account of the consumer and moves these funds to an account payable 52. The funds may remain in the account payable 53 until settlement. At settlement the funds may be transferred to the merchants financial institution by existing settlement procedures. The consumer's financial institution may also forward to the system 56 details of the transfer.

Depending on the implementation, the merchant's financial institution may receive the invoice 60 which has been routed from the system following the initial request to the system. The merchant's financial institution will open the message 61 and list as an account receivable 62 the amount of the invoice. This invoice will remain in account receivable until reconciliation 63. Once the merchant's financial institution receives funds from the consumer's financial institution 64 this is then matched with the invoice in the account receivable 65. The reconciliation process may also be carried out in real time.

The merchant is also able to keep a list of invoices 70 so as to reconcile this list with the merchant's financial institution at a later date. The merchant can receive a list of reconciled transactions 71 from their financial institution and then compare this with the list 72 so as to then reconcile the merchants accounting books 73. Alternatively, the merchant could receive details from their financial institution in real time so as to enable immediate reconciliation.

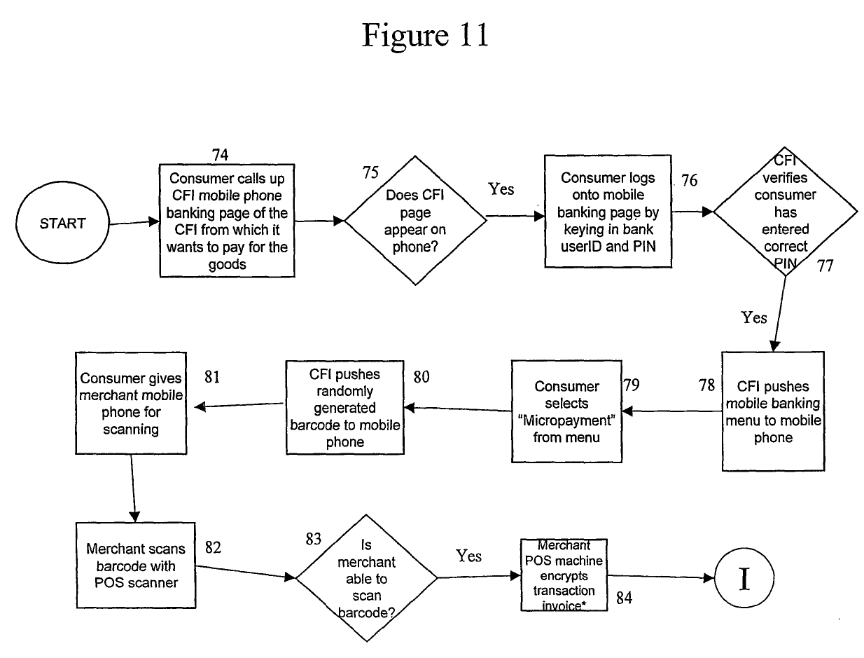

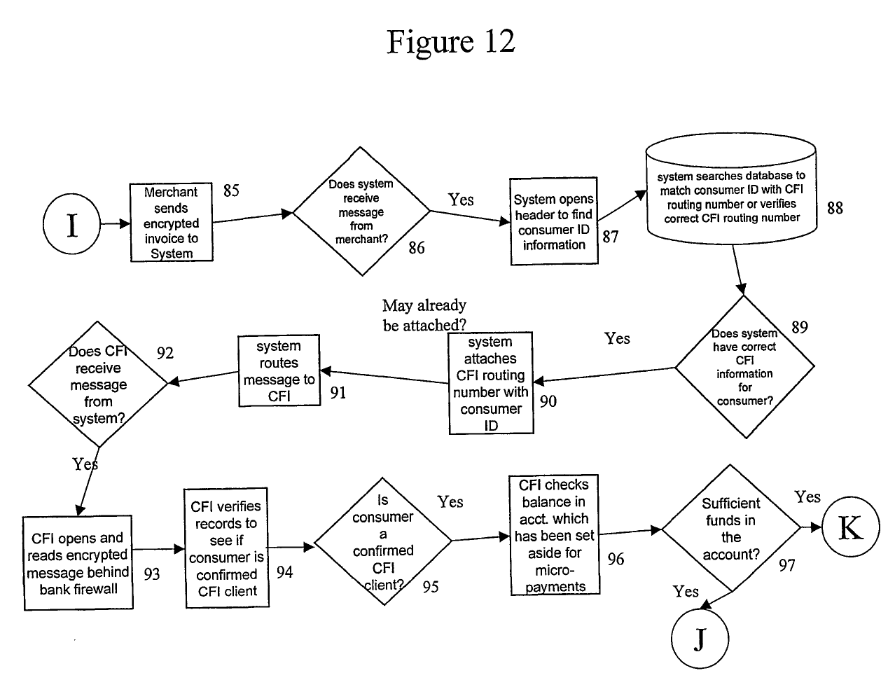

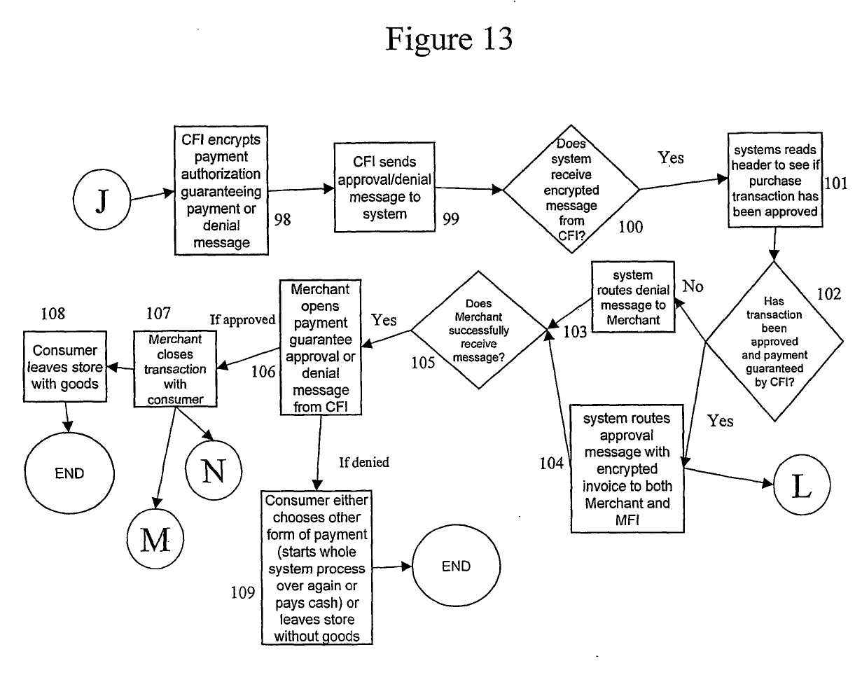

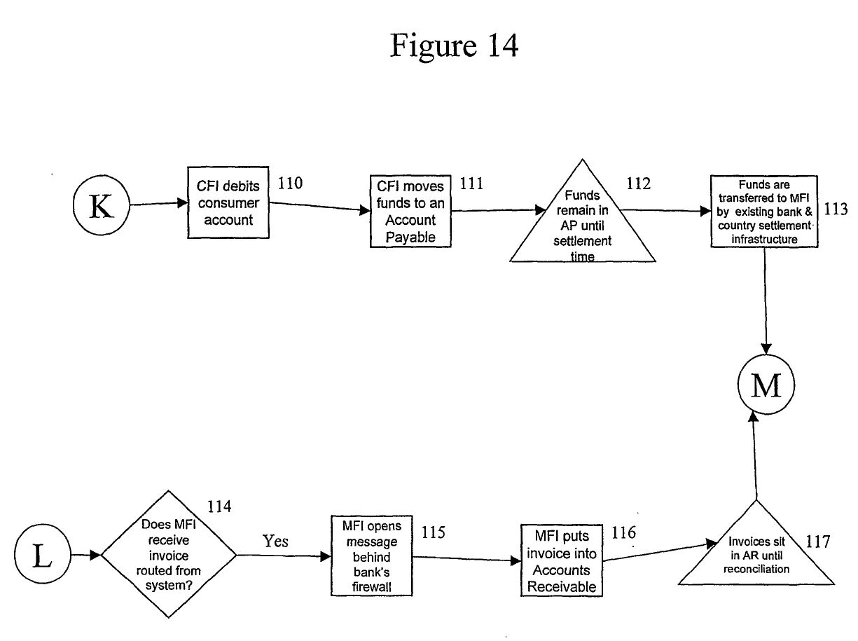

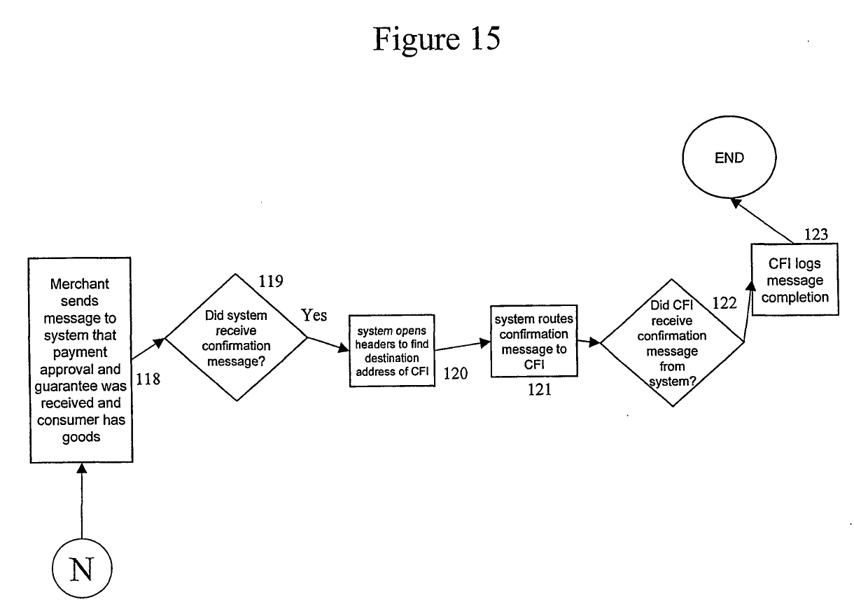

An alternative embodiment wherein a specific account is set up by the consumer is exemplified in FIGS. 11 to 15. In this arrangement once the consumer's financial institution has confirmed the consumer as a client 95, the consumers financial institution checks the balance in the account which has been set aside for the payments 96. The consumer's financial institution will then encrypt 98 a message and send this message to the system 99 either approving or denying the transaction. Part of the header to this message will include whether the transaction has been approved and can thus be read by the system 101. The system will then forward this approval 104 or denial 103 message to the merchant. Upon opening of the message 106, assuming that the purchase has been denied the consumer may either select another form of payment 109 or discontinue the transaction. Alternatively if the message received by the merchant is an approval, the transaction may continue to its conclusion.

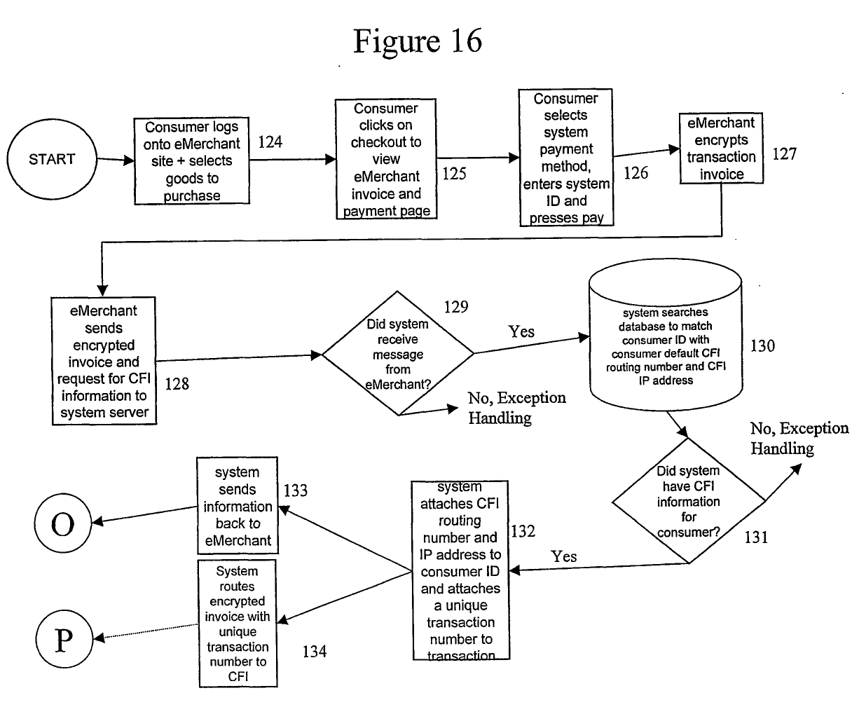

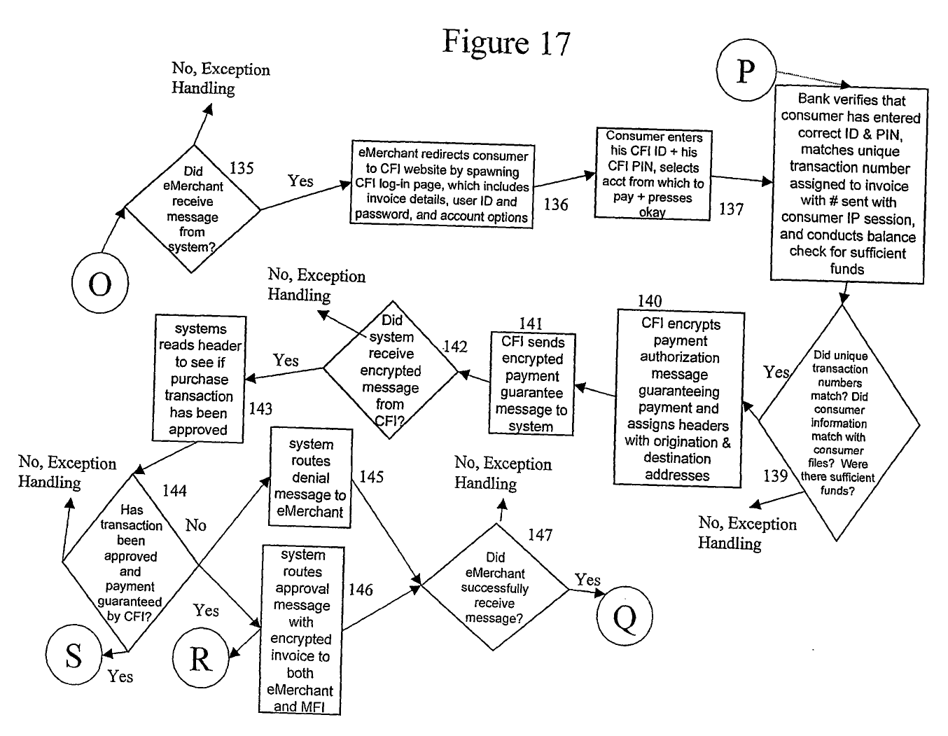

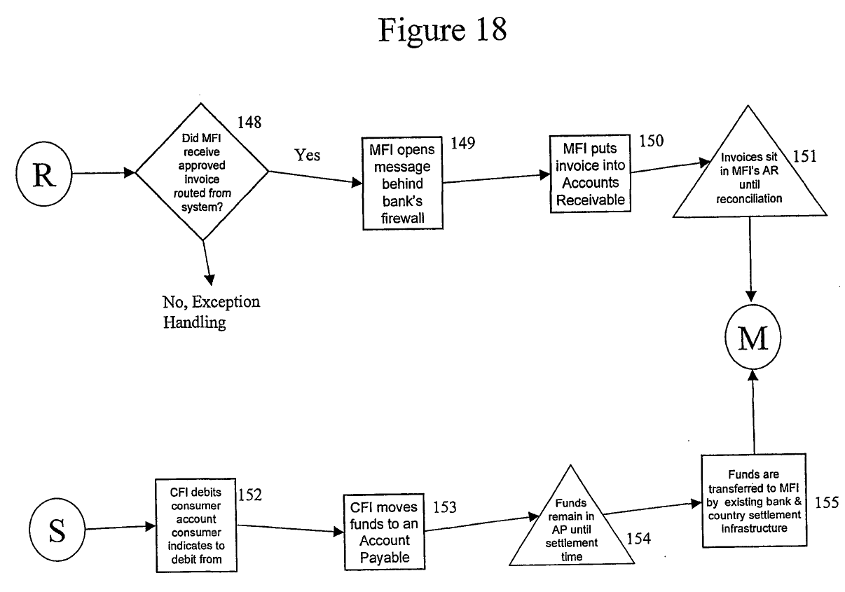

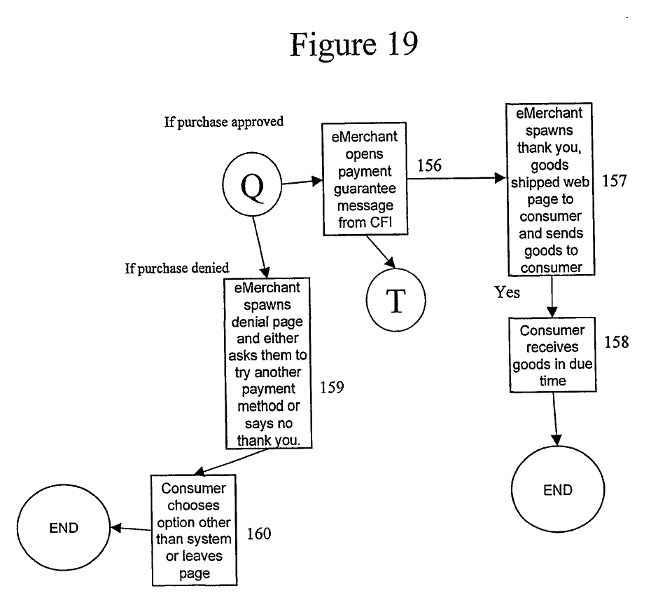

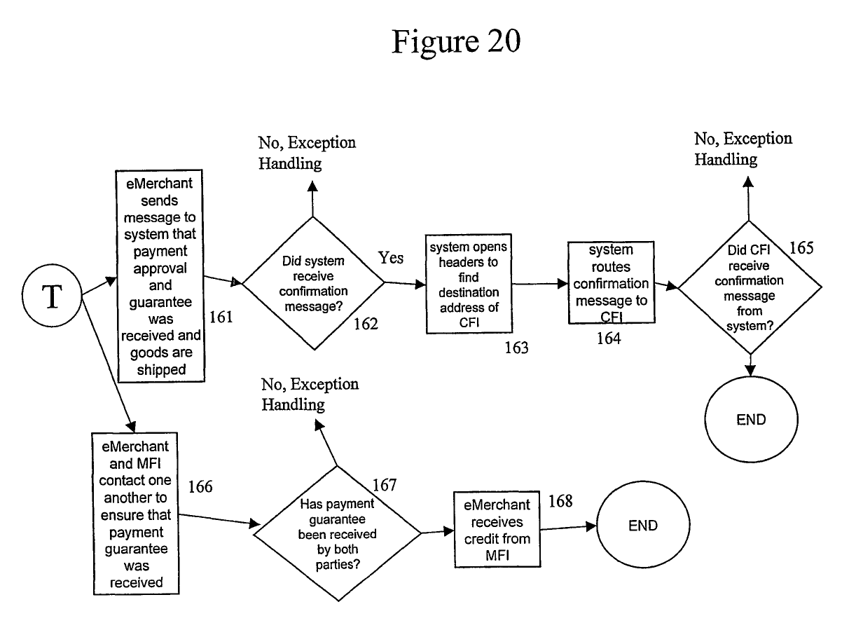

The system may also be configured to make purchases over the internet or other global computer networks. Such a system is exemplified in FIGS. 16 to 20. In this arrangement the consumer may log onto the merchant's internet site 124 and select the goods to be purchased. The consumer may then review the merchants invoice 125 and select 126 and enter the relevant ID for the system. The merchant then encrypts the transaction invoice 127 and forwards it to the system 128. Upon receipt 129 of the message the system then searches its database 130 to verify the consumer details. Once the details of the consumer are located 131 the system attaches the necessary details 132 and forwards the message back to the merchant 133 and to the consumers financial institution 134.

Once the merchant has received a message from the system 135 the merchant can then redirect the consumer to the consumers financial institution website 136 by sporning a login page which includes the invoice details, user ID, password and any other account option. The consumer enters the necessary identification and then selects the options to effect payment 137. The consumer's financial institution will then verify that the entered details are correct 138 and also check that sufficient funds are present. Assuming that the bank details match and sufficient funds are present, the system can then proceed as previously detailed. The exception of course is for goods purchased via the internet in that the consumer would not normally leave the store with such goods but rather that it would be necessary for the merchant to then ship the goods to the consumer.

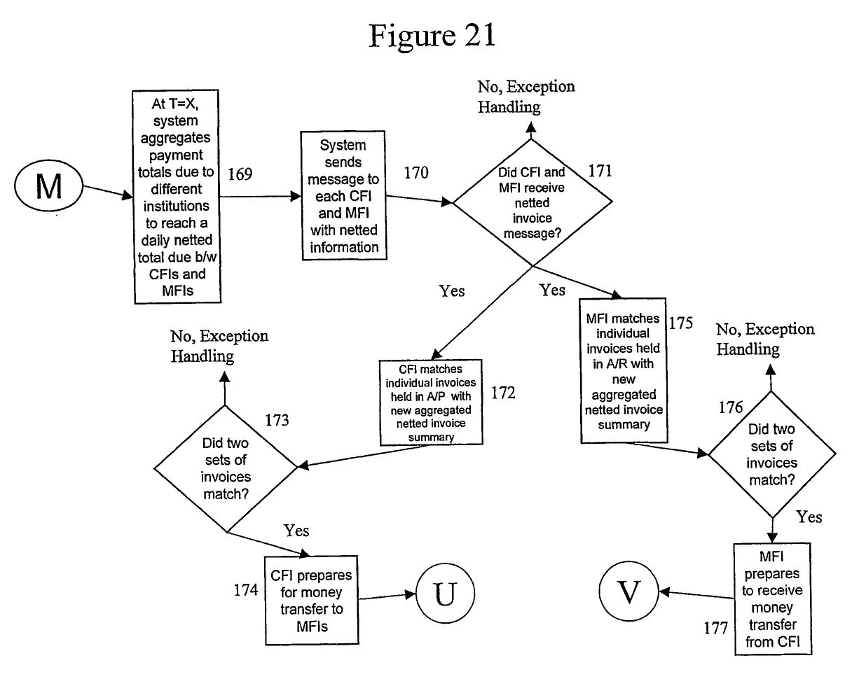

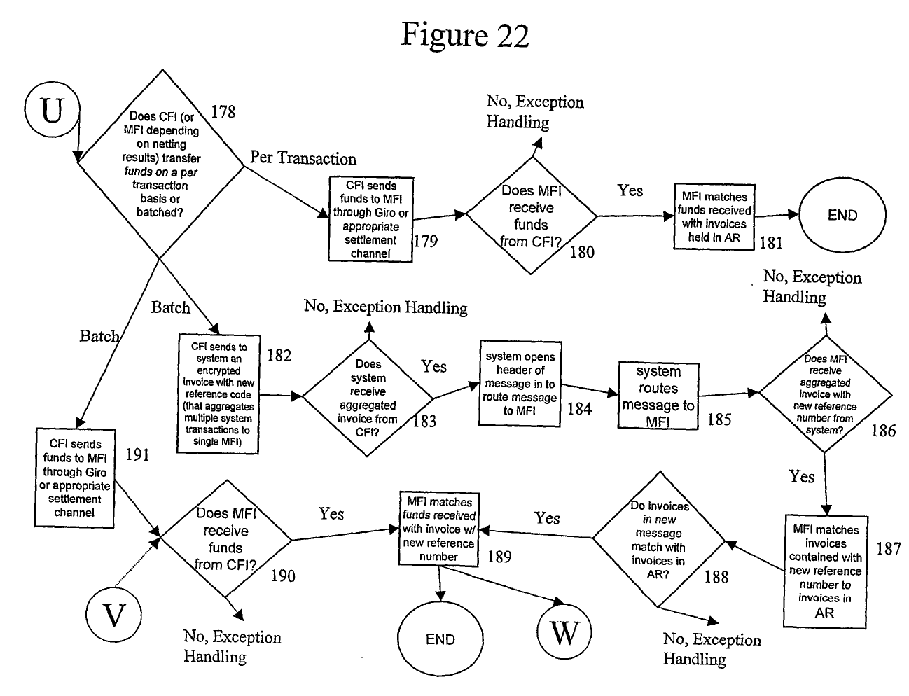

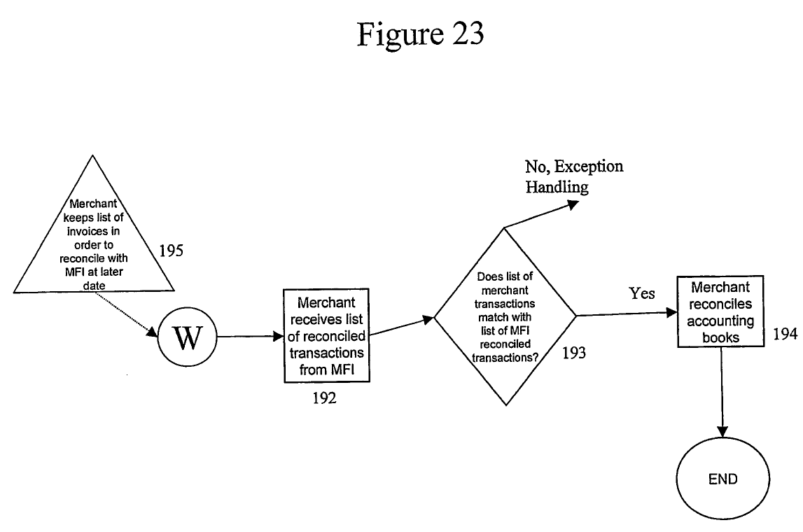

The system may further include settlement and reconciliation processes, and an example of such a process is exemplified in FIGS. 21 to 23. In the preferred system these settlement and reconciliation processes can be carried out in real time.

Referring again to the existing credit card model, whether the consumer swipes his or her credit card for a transaction and gets an authorisation, although the transaction is complete and the consumer can walk away with the goods, the consumer is left with another action. A month or so later, the consumer must go through his or her credit card bills and determine what the consumer actually charged and what he or she may not have actually charged. In other words, the consumer still has the reconciliation job ahead, which can consume a significant amount of time. On the other hand, with the system for an embodiment of the present invention, since the consumer authorises each transaction, he or she actually does his or her reconciliation immediately as part of the particular transaction.

The system for one embodiment of the present invention includes, for example, three core components. One core component is the routing functionality in the middle, which is run by the system of the present invention. The system also involves deployment of databases, which contain all of the confidential information, such as billing details, inside the financial institution. That information never leaves the financial institution. In fact, the information never actually leaves those accounts. All the confidentiality and all the security around the confidential information is actually within the financial institution. The system of the present institution is in the middle. Thus, there is a database at the consumer's financial institution and at the merchant's financial institution, and the system of the present invention has a routing database in the middle. The components of the present invention can be coupled to one another, for example, over a network, such as the Internet, utilising current security standards, such as SSL 128-bit encryption. The only need for specific lines or dial-up lines would be volume driven.

The present invention also differs from other current payment methods which are and available, which are actually quite similar to the existing credit card type model in some ways. Most currently available payment methodologies contain confidential consumer information. For example, when a consumer registers with an existing payment service, the consumer actually provides his or her confidential information to the payment service. However, when a consumer registers with the system of the present invention, the consumer provides no information to the system that cannot be found, for example, in a telephone directory or a web directory of email addresses.

Thus, an existing payment service, in many ways, typically acts as a bank that contains confidential information. However, in registering with the system for an embodiment of the present invention, the consumer is registering with the bank where he on she already has his or her confidential information, where there is already regulatory control of that information, and where there are already security standards. All the consumer does is use the system of the present invention for routing.

The peer to peer (P2P) model for an embodiment of the present invention represented, for example, in Diagram 3, enables payers 9 to make payments to payees 11. For example, if a payer 9 wishes to pay money to a payee 11, the payer 9 sends a reverse invoice to the payee 11 asking the payee if he or she would like for the payer 9 to pay $50 to the payee 11. The payee 11 can respond, at which time, the payer's account number is sent directly to the financial institution 10, and the payment occurs through the standard settlement process. Again, the registration process for the system of the present invention is performed through the consumer's financial institution 10, and the only information that is passed to the system of the present invention is information that is necessary for routing, such as the consumer's identification forms, hot mail address, or telephone number.

An important aspect of the system for an embodiment of the present invention is its use through the Internet. In using the Internet today, if a consumer uses his or her credit card, the consumer is exposed to all of the disadvantages of the credit card, such as anyone in possession of certain features of the consumer's credit card can transact. To insure against “cards-not-present” transactions, it can cost a web merchant up to 8% of revenue. The system for an embodiment of the present invention allows the consumer to completely avoid any of the forward risk, because if an unauthorised third party fraudulently obtains the consumers email address and attempts to fraudulently initiate a transaction, since the third party does not have access to the consumer's PIN number or bank account, the consumer's intervention is required to actually execute the transaction.

At the same time, the system for an embodiment of the present invention provides a benefit to certain parties on the Internet, because it does not disintermediate the actual payers' and payees' financial institutions, which is what many existing payment services attempt to do. Also, virtually all of the existing payment service models in the marketplace require some degree of direct contact between the payment service and the customers. Thus, existing payment services typically insert themselves into a relationship that is already established between the bank and its customer. On the other hand, the system of the present invention is a bank-centric model. The only contact the system ever has with a customer is if the customer is not registered, the system, for example, sends an email to the customer notifying him or her that he or she has money waiting and asking the customer to please register with one of the participating banks.

The present system seeks to route payment information rather than capital. Because payment invoices and not capital are moved in the process no regulatory conflict exists, current security mechanisms are leveraged, and consumer purchase information is only kept by relevant parties. The present system has the advantage of competing with all existing payment methods and provides the consumer with the choice of payment method through the one system, where as previously the consumer had to select which system to use whether it be cash, cheque, debit card or credit card. The present system seeks to reinforce established relationships between consumers, merchants and there respective financial institutions. An advantage of the system is that further collation and aggregation of consumer confidential information should not be required. Further, the present system can be implemented through any financial institution and need not be affiliated with a particular institution or organisation.

Various preferred embodiments of the invention have been described in fulfilment of the various objects of the invention. It should be recognised that these embodiments are merely illustrative of the principles of the invention. Numerous modifications add adaptations thereof will be readily apparent to those skilled in the art without departing from the spirit and scope of the present invention.

1. A method for performing a transaction to enable a consumer to purchase a good or service from a merchant, said method including the steps of:
a) said consumer providing identification to said merchant;
b) said merchant forwarding purchase details to a processing means, said purchase details including purchase value and consumer details indicated by said identification;
c) said processing means verifying said consumer details and forwarding said purchase details to a first financial institution, said consumer having an account with said first financial institution;
d) said first financial institution verifies said consumer details and forwards a message to said consumer requesting authentication of said transaction;
e) said consumer replies to said first financial institution authenticating said transaction;
f) said first financial institution forwards a message to said processing means authorising said transaction and arranges transfer of funds to a second financial institution, said merchant having an account with said second financial institution; and
g) said processing means advising said merchant that said transaction is authorised.

2. A method as claimed in claim 1 wherein said first and second financial institutions are the same.

3. A method as claimed in claim 1 or 2, wherein said purchase details are encrypted.

4. A method as claimed in any preceding claim wherein said identification includes an email address, mobile phone number or alphanumeric code.

5. A method as claimed in any preceding claim wherein said first financial institution verifies said consumer has sufficient funds to complete the transaction.

6. A method as claimed in any preceding claim wherein a portion of said identification is provided by said first financial institution.

7. A method as claimed in claim 6 wherein said portion includes a barcode.

8. A method as claimed in claim 7 wherein said merchant scans said barcode to obtain said identification.

9. A method as claimed in any preceding claim further including the step of said first financial institution reconciling said transaction with said consumer.

10. A method as claimed in any preceding claim further including the step of said second financial institution reconciling said transaction with said merchant.

11. A method as claimed in any one of claims 1 to 10 wherein each said step is carried out in real time.

12. A system to facilitate the purchase of goods and/or services from a merchant by a consumer, including:
a) a first financial institution holding an account of said consumer;
b) a second financial institution holding an account of said merchant; and
c) a processing means; wherein said merchant obtains identification from said consumer and forwards purchase details to said processing means, said processing means verifies consumer details and forwards purchase details to said first financial institution, said first financial institution seeks authentication of said transaction from said consumer and upon receiving authentication forwards authorisation to said processing means and initiates payment to said second financial institution, and said processing means forwards approval to said merchant.

13. A system as claimed in claim 12 wherein said first and second financial institutions are the same.

14. A system as claimed in claim 12 or 13, wherein said purchase details are encrypted.

15. A system as claimed in any one of claims 12 to 14 wherein said identification includes an email address, mobile phone number or alphanumeric code.

16. A system as claimed in any one of claims 12 to 15 wherein said first financial institution verifies said consumer has sufficient funds to complete the transaction.

17. A system as claimed in any one of claims 12 to 16 wherein a portion of said identification is provided by said first financial institution.

18. A system as claimed in claim 17 wherein said portion includes a barcode.

19. A system as claimed in claim 18 wherein said merchant scans said barcode to obtain said identification.

20. A system as claimed in any one of claims 12 to 20 wherein said second financial institution performs a reconciliation process with said merchant.

21. A system as claimed in any one of claims 12 to 21 wherein said first financial institution performs a reconciliation process with said consumer.

22. A system as claimed in any one of claims 12 to 16 and claims 20 to 21 wherein said system operates in real time.

23. A system to facilitate the purchase of goods and/or services in real time from a merchant by a consumer, wherein said system provides said consumer with a unique identification, upon authentication by consumer who verifies and authorises transactions of said consumer in real time, and wherein said system receives consumer identification and purchase value from said merchant, said system verifies said consumer identification includes said unique identification and forwards said consumer identification and said purchase value to a first financial institution nominated by said consumer and awaits authorisation, said system receives said authorisation from said first financial institution and forwards said authorisation to said merchant.

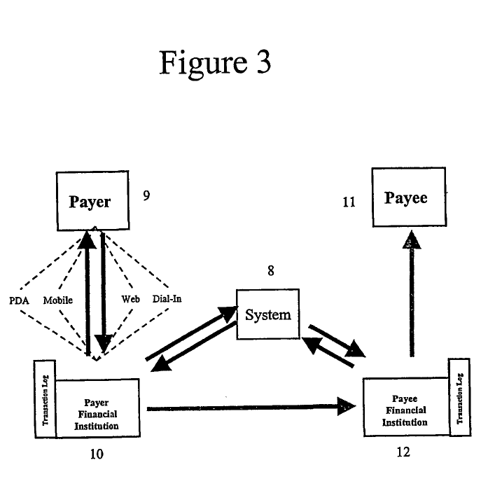

24. A method or system substantially as hereinbefore described with reference to FIGS. 2 to 23 of the accompanying drawings.
